(19) United States
(12) Patent Application Publication
(10) Pub. No.: US 2007/0259109 A1
(43) Pub. Date: Nov. 8, 2007

(54) Large Scale Surface Modification of Microfluidic Devices

(75) Inventor: Gosta Sorndal, Uppsala (SE)

Correspondence Address: FULBRIGHT & JAWORSKI, LLP, 1301 MCKINNEY, SUITE 5100, HOUSTON, TX, 77010-3095, US

(73) Assignee: Gyros Patent AB, SE 751 83 Uppsala (SE)

(21) Appl. No.: 10/585,056

(22) PCT Filed: Dec. 29, 2004
(86) PCT No.: PCT/SE04/02030

§ 371 Date: Apr. 26, 2007

Related U.S. Application Data
(60) Provisional application No. 60/534,832, filed on Jan. 7, 2004.

(30) Foreign Application Priority Data
Jan. 2, 2004 (SE) 0400007-1

(51) Int. Cl. B05D 3/12

(52) U.S. Cl. 427/240; 427/294

(57) ABSTRACT

A method for the modification of an inner surface in each of one, two or more microchannel structures of a microfluidic device. Each of the microchannel structures comprises one, two or more ports (PT) communicating with ambient atmosphere. The microconduit part comprises the inner surface to be modified. The method comprises for each microchannel structure the steps of: (I) filling the microconduit part with a liquid containing a surface modification agent through at least one port (PT′) of said one, two or more ports (PT), (II) incubating said liquid within said microconduit part, and (III) removing said liquid from said microconduit part, for instance from the microchannel structures comprising said microconduit part. The method is characterized in that reduced pressure is utilized for filling in step (I).

### TECHNICAL FIELD

The present invention relates to a method for the modification of an inner surface of one, three or more of the microchannel structures that are present within a microfluidic device.

Modification of an inner surface in the context of the present invention encompasses changing chemical and/or physical surface characteristics of a liquid contact surface within a microchannel structure of a microfluidic device, i.e. modification of a surface that is to be brought into contact with liquid during the use of the microchannel structure.

All patent applications and issued patents cited herein are hereby incorporated in their entirety by reference.

### BACKGROUND TECHNOLOGY

During the last two decades there has been a large interest in designing microfluidic devices in which volumes of liquids that are in the μl-range and contains reactants and/or reagents can be transported and processed. The transportation and processing have typically had preparative, analytical and/or synthetic purposes. Analytical purpose have typically been related to process protocols in which an unknown (analyte) has been characterized according to one or more features such as amount, activity, structure, identity etc. Typical analytical protocols has encompassed catalytic assays such as enzymatic assays, recetor-ligand assays such as immuno assays, cell based assays etc.

Important goals are to integrate several process steps of a protocol into the same microchannel structure and/or to carry out such protocols with a high degree of parallelism to obtain accurate, reproducible and reliable results. It has become important with cheap and efficient manufacturing methods that give low inter channel variations in inner surface characteristics and/or in the results obtained for parallel runs of the same experiment in different structures. The goal with low inter channel variation applies between devices and within the same device. One of the main goals has been to reduce the costs so that the devices can be used as disposals.

The inner surfaces of microchannel structures of microfluidic devices typically need to be modified physically and/or chemically with respect to the particular protocol to be performed, reagents, reactants and liquids to be used, etc. Typical surface modifications may be local or extend throughout essentially all parts a microchannel structure in which liquids are to be transported and processed. If capillary action, for instance, is relied upon for liquid transport and the liquid is polar and aqueous, the inner surfaces often have to be modified to provide a sufficient wettability for capillary transport, typically by introducing a wettable surface coat. If there is a risk for unacceptable adsorption of reactants and/or reagents, the surface modification should also secure a sufficiently low undesired adsorption of these molecular species, typically by introducing a coat lowering undesired adsorption and increasing wettability. Non-wettable local surface areas (hydrophobic breaks) that can be used in passive valve functions, vent functions, anti-wicking functions etc may also be introduced by modification of chemical surface characteristics. If an intended process protocol comprises heterogeneous reactions, i.e. reaction between a solute and a solid phase bound reactant, an inner surface often needs to be modified to properly expose the solid phase bound reactant and/or to enlarge the available surface area, i.e. changes in chemical and physical surface characteristics. A change in physical surface characteristics by surface enlargement may comprise introduction of a porous bed, for instance a packed bed or a porous monolithic plug.

The process protocol to be used in the ready-made device may also comprise one or more steps that inherently means modification of an inner surface. In the case the protocol comprises a heterogeneous reaction of the type discussed in the preceding paragraph, for instance, there often is included a step in which a soluble reactant is captured on a solid phase. This soluble reactant may be an analyte, or a reactant that is to interact in a subsequent step with an analyte or with some other reactant that is present in a liquid that is transported and processed in the microchannel structure. This latter interaction may include binding/capturing of the reactant to the solid phase or a reaction leading to an insoluble and/or precipitated product and/or to a soluble product.

Previously two main routes have been used for modification of inner surfaces of microfluidic devices. The first route encompasses modification of the surfaces of uncovered microchannel structures that are present in the surface of a substrate. The substrate surface is subsequently covered with a lid. The second route encompasses that one starts with the enclosed form of the microchannel structures and then introduces a surface-modifying liquid into the microchannel structures. After a suitable incubation time the liquid is removed. Each route typically has its own preferences with respect to particular surface modification processes. It is often beneficial to utilize both routes. See for instance WO 03086960 (Gyros AB), WO 0147638 (Gyros AB), WO 0056808 (Gyros AB), WO 9800709 (Amersham Pharmacia Biotech AB), WO 04067444 (Gyros AB). None of the two routes is adapted for parallel modification of two or more microfluidic devices. During our search for cost effective manufacturing methods we have also found that for the second route there are often problems with parallel filling of microchannel structures of the same microfluidic device.

Monahan et al (Anal. Chem. 73 (2001) 3193-3197) have presented a method for filling complex polymeric microfluidic devices and arrays with liquid by utilizing reduced pressure.

### DRAWINGS

FIG. 1 illustrates a part of a circular microfluidic device comprising a plurality of microchannel structures in which there are inner surfaces to be modified.

FIG. 2 illustrates the various steps of the method and also an arrangement for carrying out the method.

FIG. 3 illustrates an optimized variant of the arrangement.

The first digit in a reference number is the number of the drawing. The second and the third digit refer to the item contemplated.

### OBJECTS OF THE INVENTION

The main object of the invention is to provide an improved method for surface modification of inner surfaces of a microfluidic device. It should be possible to perform the method with a high degree of parallelism with respect to number of microchannel structures and/or microfluidic devices. The method should give a low inter and/or intra device inter channel variation of the inner surfaces as apparent from variations of the results obtained by the use of the microfluidic devices.

Invention

### SUMMARY OF THE INVENTION

The present inventor has recognized that these objects can be achieved if reduced pressure is employed in the proper manner for introducing a liquid containing a surface modification agent into those microchannel structures in which there are inner surfaces to be surface modified.

One main aspect of the invention thus is a method for the modification of an inner surface of a microchannel structure (152) that is part of a microfluidic device (203;303;150) containing one or a plurality of microchannel structures (152a,b . . . ) to be surface modified. The microchannel structure has one or a plurality of ports (157;158;159;164a-h;178a-l;179;180a-l;181) through which its interior is communicating with ambient atmosphere. One or more of these ports may be used for introducing liquid into the interior of a microchannel structure while others may be closed and/or permit venting of air in order to assist proper filling of a microchannel structure with a liquid. The ports of the microchannel structure at this stage of the manufacturing do not need to be present in or have the same function as in the ready-made device. Introduction of a liquid used for surface modification may, for instance, take place through an opening that in the ready-made device is non-existent (closed), is used for venting excess of air or is used for discharging excess or waste liquids. The ports/openings (157;158;159;164a-h;178a-l;179;180a-l;181) in the microchannel structures (152a,b . . . ) to be surface-modified according to the invention will henceforth be called modification ports or simply MPs or M-ports.

The method comprises for each of said microchannel structures the steps of:
(I) filling a microconduit part (=microconduit) that comprises the inner surface with a liquid containing a surface modification agent through at least one of the ports available port in the microchannel structure (157;158;159;164a-h;178a-l;179;180a-l;181),
(II) incubating said liquid within said microconduit part, and
(III) removing said liquid from said microconduit part, for instance from the microchannel structure (152) comprising said microconduit part.

The characteristic feature is that reduced pressure is utilized for step I, i.e. by creating reduced pressure inside at least a part of each of the microchannel structures (152) liquid will enter and enter/fill the microconduit part (sucking of liquid).

In preferred variants the microfluidic device (203a,b . . . ;303a,b . . . ;150) comprises a plurality of microchannel structures (152a,b . . . ) to be surface modified in parallel by the method. In other preferred variants the method comprises surface modification in parallel of a plurality microchannel structures in a plurality of microfluidic devices (203;303;150).

Parallel in this context typically means that each microchannel structure and/or microfluidic device undergoes one, two, or three of steps (I)-(III) essentially simultaneously. A step in this context contemplates the actual filling, actual incubation or the actual removing.

The term “plurality” in the context of microchannel structures and microfluidic devices comprises two, three or more of the particular item concerned.

Suitable circular microfluidic devices comprising a plurality of microchannel structures (152a,b . . . ) that can be surface-modified according to the invention are discussed under the heading “Microfluidic Devices”.

The microfluidic device may comprise microchannel structures that will or has been surface-modified separately at another occasion by a method that is a variant of the method of the invention or by a completely different method. The microfluidic device may also contain microchannel structures that are not to be surface-modified.

Each M port may function as an inlet and/or an outlet for liquid and/or as an inlet and/or an outlet for gases in the method of the invention. An M port (157;158;159;164a-h;178a-l;179;180a-l;181) may be linked to a single microchannel structure (178a-l;179;180a-l) or be common (157;158;159;181) for two or more microchannel structures. Thus the port through which liquid is introduced may be common for a subgroup (151) of microchannel structures (152a-l) of a microfluidic device (150). Such a subgroup may typically comprise 2-20, such as ≦15 or ≦12≦8, microchannel structures and typically comprises always two, three, four or more microchannel structures.

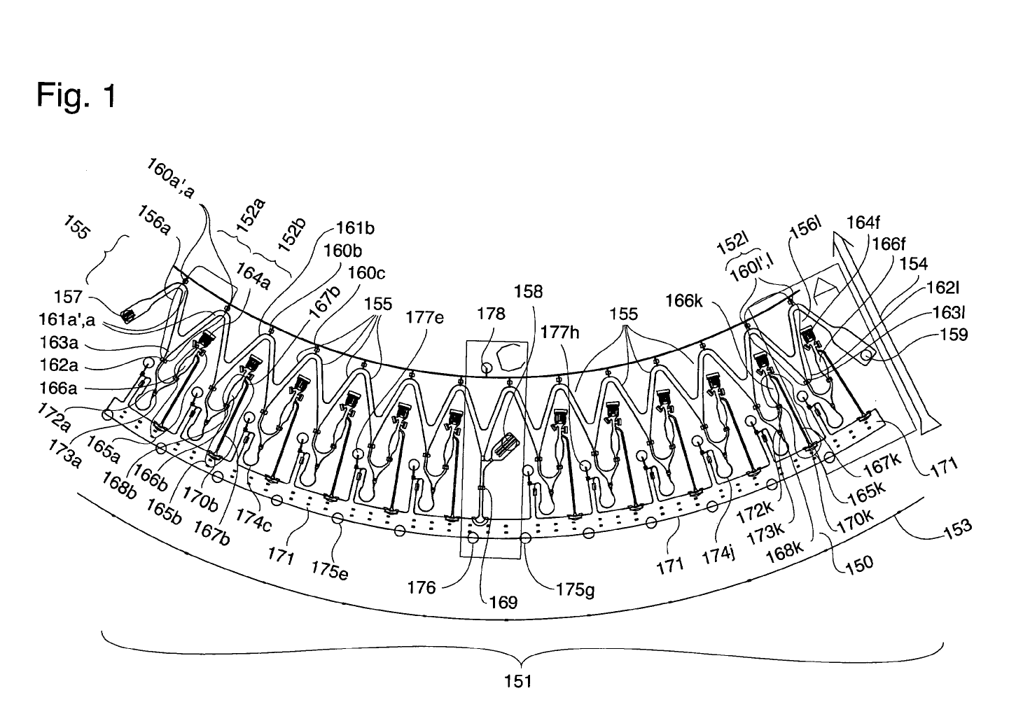

The microconduit part may comprise two separate ends between which the inner surface to be modified is located. Each of these separate ends may be communicating with one or more M ports (MP₁s and MP₂s, respectively) of the microchannel structure without passage through the microconduit part. There may also be one or more M ports (MP₃) communicating with the microconduit part at the position of the inner surface to be modified. In FIG. 1 the microconduit part of a microchannel structure (for instance 152i) may for instance be located between ports (157) and (178i), between ports (157) and (159), between ports (158) and (178i or 179) etc.

An M port is typically a port that also is present in the ready-made microfluidic device. An M port may also be a port that is only used during the manufacture of the device, i.e. a port that is irreversibly closed/non-existent in the ready-made device. Compare for instance WO 03099438 (Univ. Alberta) which describes physical surface modifications by entrapments of particles introduced via a side-channel.

### DETAILED DESCRIPTION OF THE VARIOUS STEPS OF THE INVENTION

In one variant of the method of the invention, the main characteristic features comprise that
(a) an inner surface to be modified is part of a microconduit part that via separate ends is communicating with ambient atmosphere via separate ports (MP₁ and MP₂, respectively) as described in the preceding paragraph and
(b) step I (filling) for each of the microchannel structures comprises sucking a liquid used according to the invention through one or more of the MP₁ ports (e.g. 157;158;159;164) by applying reduced pressure through one or more of the MP₂ ports (e.g. 178a-l;179; 180a-l), or the other way round with reduced pressure being applied through one or more of the MP₁ ports.

If present, remaining ports that are not utilized in the sucking are typically closed. As discussed above for ports in general, one or more of the MP₁ ports and/or one or more of MP₂ ports may be linked to a single microchannel structure or be common for a subgroup of microchannel structures.

In another variant which is preferred, the characteristic feature is that the filling step (step (I) comprises the steps of:
(i) providing
   A) a closed vessel (201;301) that contains a liquid (205;305), in which there is a surface modification agent, and a gas phase (206), and
   B) a microfluidic device (203;303) that comprises one or a plurality of microchannel structures (152) to be surface-modified each of which structure/structures is/are empty and via at least one port (MPs) (157;158;159;164a-h;178a-l;179;180a-l;181) is in contact with the interior of the vessel either a) with the liquid (205;305) that is present in the vessel, or b) with the gas phase (206;306) that is present in the vessel,
(ii) reducing the pressure of the gas phase (206;306) in the vessel,
(iii) bringing said at least one M port referred to in (B) in liquid contact with the liquid referred to in (A), if step (i) is according to alternative (b),
(iv) increasing the pressure of the gas phase (206;306) in the vessel (201;301), typically to the starting pressure.

In step (i) the liquid (205;305) that contains the surface modification agent may be introduced into the vessel (201;301) either before or after said at least one of the MPs is brought into contact with the interior of the vessel.

Liquid contact between an M port includes that a microfluidic device is fully or partially submerged into the liquid. Step (iii) (bringing) thus comprises anything from contacting only the M ports intended with the liquid that is present in the vessel to submerging partially or completely the microfluidic device into the liquid.

The liquid containing the surface modification agent will fill at least the microconduit part of a microchannel structure during and/or after step (ii) for alternative (a) and during and/or after step (iv) for alternative (b). The liquid may stop at mechanical valves that are in a closed position. The liquid may also stop at passive or capillary valves if the reduction in pressure is not sufficient to overcome the flow resistance created at the particular passive/capillary valve concerned.

After step (i) and before step (ii) each microchannel structure to be surface-modified is empty in the sense that it contains a gas phase of pressure P₁ that is the same as the gas pressure in the vessel before step (ii) and typically is the same as the pressure of ambient atmosphere. After step (ii) the gas pressure in the vessel is P′<P₁. Suitable pressures P₁ are found in the interval 1000±100 mbar. Suitable pressures P′ are found in the interval 0.01 P₁<P′<0.9 P₁, such as 0.01 P₁<P′<0.5 P₁

In both variant (a) and (b) referred to in step (i) the remaining ports, if any, are typically closed.

The microfluidic device is in preferred variants completely placed within the vessel during step (ii), step (iii) if present, and step (iv). The microfluidic device may in other variants be placed partly or fully outside the vessel during these steps, e.g. at least a part of each microchannel structure is outside the vessel. In both variants, the port(s) (=PT's) through which liquid is to be introduced into a microchannel structure is(are) is in contact with either the liquid or the gas phase of the vessel as discussed above.

Each of the ports (PT's) through which liquid is introduced into a microchannel structure may be one end of a capillary tube that is attached via its other end to the body of the microfluidic device. This body typically comprises the major part of each of the microchannel structures. Variants utilizing this kind of capillary tubes are particular useful when selective introduction of liquid into predetermined ports without submerging the device into the liquid is desired. This use of capillary tubes will avoid contamination of the body of the microfluidic device including other ports with the surface-modifying liquid.

### DETAILED DESCRIPTION OF SUITABLE MICROFLUIDIC DEVICES AND ARRANGEMENT TO BE USED

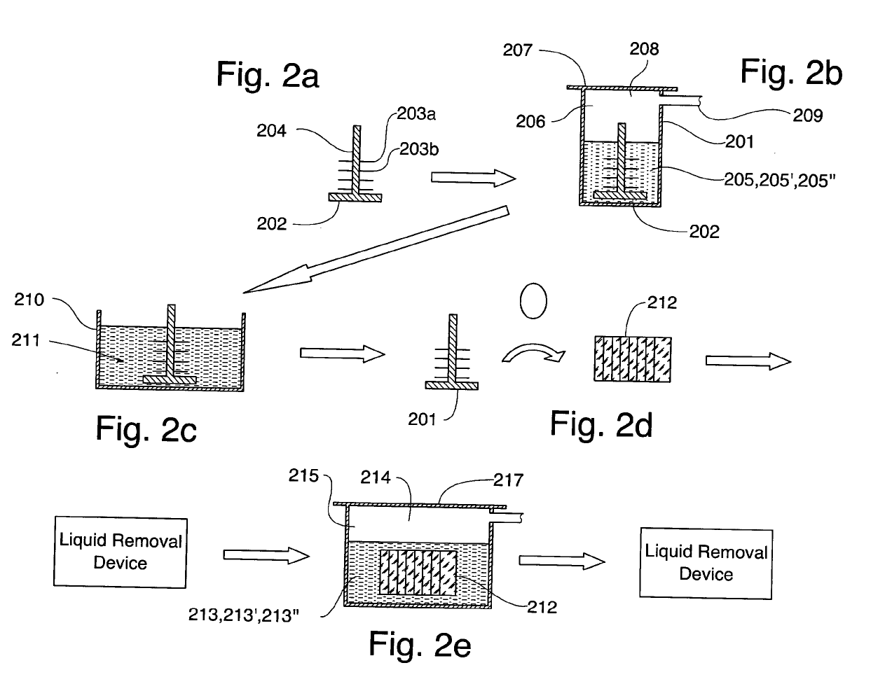

FIGS. 2a-b show a vessel (201, first vessel) that corresponds to a container for surface-modifying liquid used in step (I), such as provided in step (I:i), and a holder (202, first holder) for one or a plurality of the microfluidic devices (203a,b . . . ) in which there are one or more microchannel structures to be surface modified. The holder (202) may comprise a pin (204), and the microfluidic devices (203a,b . . . ) indicated may be circular. The microfluidic device(s) (203a,b . . . ) may be mounted on the holder (202), for instance through a hole that may be in the center on a device (203). The vessel (201) may contain a liquid (205) to be introduced into the microchannel structures, and a gas phase (206). The holder (202) should in preferred variants enable a simple way for parallel handling and processing of a plurality of microfluidic device(s) (203a,b . . . ). The holder (202) with its microfluidic devices (203a,b . . . ) typically should fit smoothly into the vessel (201) in order to minimize the amount of surface-modifying liquid needed. The reason for smooth fitting is that these kinds of liquids typically are precious compared to more simple solutions such as washing liquids, conditioning liquids and the like.

FIG. 2b further shows that the first vessel (201) is closeable and contains an openable closure (207) that is able to tightening block the opening (208) through which the holder (202) with one, three or more microfluidic devices (203a,b . . . ) or one or more single microfluidic devices without holder can be inserted. The first vessel (201) is connected to a sub pressure source (not shown) via conduits (209) that may contain a valve function (not shown). The vessel may also comprise a function for the introduction of liquid and a function for discharging liquid. Each of these functions typically comprises a valve function and conduits for guiding liquid to and from the vessel (201). In their simplest versions these two functions may contemplate that liquid is poured into or out of the vessel, respectively, for instance through the same opening (208) as utilized for inserting the holder (201) and/or the microfluidic device(s) (203a,b . . . ). The method according to the invention typically comprises that a liquid containing a surface modification agent is introduced into the first vessel (201). In repetitive rounds of the method and also in preceding steps other surface-modifying liquids (205′) or liquids (205″) not containing a surface modification agent may be placed in this first vessel (201), for instance conditioning liquids, washing liquids, liquids containing surface modification agents in other concentrations and/or of other kinds. This kind of other liquids may be introduced into one or more of the microchannel structures of the microfluidic device by utilizing reduced pressure in the same manner as described for step (I) of the present invention.

FIG. 2c illustrates that the set up may comprise a separate vessel (210, washing vessel) for washing the exterior of the microfluidic devices (203a,b . . . ) in a washing liquid (215) after the actual modification of inner surfaces of a microfluidic device have taking place, i.e. after step (II). A washing vessel (210) of this type preferably has an inner geometry and volume that permit submerging simultaneously all of the microfluidic devices (203a,b . . . ) treated in parallel in the previous steps, preferably while being retained on the same holder (202) as used in the first vessel (201). The washing vessel (210) shown is not adapted for introducing washing liquids into the microchannel structures of a microfluidic device (203) by utilizing reduced pressure.

FIG. 2d illustrates that the holder (202, first holder) used during the actual steps during which an inner surface is modified may be replaced with a holder (211, second holder) fitting to the vessels or apparatus used in one or more steps after step (II), for instance drying steps or other steps during which liquid is removed from the microchannel structures of the microfluidic devices (203a,b . . . ). This may be important in the case the available device or apparatus used for removing liquid requires a holder (212) that when loaded with microfluidic devices (203a,b . . . ) is larger than the first vessel (201). If the inner geometry of the first vessel (201) would be adapted to the holder (212) used in this kind subsequent steps the consumption of precious surface-modifying liquids will increase sometimes making the costs for these liquids indefensible.

FIG. 2e illustrates that the method according to the invention may comprise additional rounds comprising steps (I)-(III) in which the liquid (213) filled into the microchannel structures may or may not contain a surface modification agent, for instance by being a washing liquid (213′) or a conditioning liquid (213″), and a gas phase (214). This kind of repetitive rounds may be carried out in a second closeable vessel (215) placed downstream the first closeable vessel (211) and/or downstream a washing vessel (210). This second closeable vessel (215) may have an openable closure (217) and may via conduits (216) be connected to a sub pressure source (not shown) that may be the same as or different from the sub pressure source of the first vessel (201). The second closeable vessel (215) may also have functions for introducing and/or discharging liquids into and from the vessel (215) the same general manner as for the first vessel (201), for instance be equipped with valve functions and/or inlet and/or outlet conduits (not shown) or the openable closure (217). The second closeable vessel (215) may in certain variants be the same as or be essentially identical with the first vessel (201). In the variant illustrated, the second closable vessel (215) is primarily intended for relatively cheap liquids such as washing liquids (213′) and conditioning liquids (213″) that preferably can be used in large excesses. The second closeable vessel (215) has an inner geometry which is adapted to a holder fitting into a subsequent drier. Compare the description of FIG. 2d above.

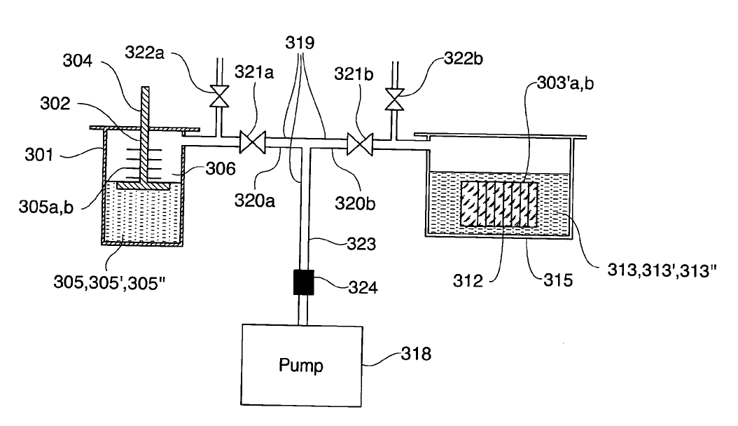

FIG. 3 illustrates an optimized arrangement comprising first closeable vessel (301) that may contain a first holder (302) carrying a first set of microfluidic devices (303a,b . . . ) and a second closeable vessel (315) that may contain a second holder (312) carrying a second set microfluidic devices (303′a,b . . . ). The second set may previously have been surface-modified according to the invention in the first vessel (301). The two vessels (301,315) typically have the same functions as outlined for the two closeable vessels (201,215) shown in FIG. 2.

Each vessel (301,315) is communicating with a source (318) for sub pressure via a T-branched conduit (319) in which each of the branches (320a,b) that leads to a vessel (301,315) has a valve (321a,b), and a vent (322a,b) to ambient atmosphere. The common part (323) of the T-branched conduit (319) may have a trap (324) for moisture and liquid. The source (318) for reduced pressure may be common for the two vessels (301,315)

The first vessel (301) typically may contain a surface-modifying liquid (305), for instance containing a polyethylene glycol-polyethylene imine conjugate as described in WO 0056808 (Gyros AB), and a gas phase (306). If the first vessel is used for a second round of steps (I)-(III) on the same set or a subset of the microfluidic devices used in the first round, the liquid used in step (I) of the first round may have been replaced with another liquid. Such other liquids may contain another kind or combination of surface modification agents and/or have another concentration of the surface modification agent used in the first instance or be a washing liquid (305′), a conditioning liquid (305″) etc. Similarly, the second vessel (315) may contain a liquid (313) and a gas phase (314) as discussed for the second closeable vessel (215) of FIG. 2.

The holder(s) that is used in step (I) and/or step (Iii) preferably has a shaft (304) that slidable is passing through the closure enabling submerging a holder together with a set of microfluidic devices into the liquid. See for instance the first vessel (301) of FIG. 3 where the shaft (304) corresponds to the pin (204) in FIG. 2. This submerging may take place before or after reduced pressure of the gas phase has been created within a vessel, for instance according to variants with or without step (iii), i.e. according to variant (b) or variant (a), respectively, of step (i). A set up with a slidable holder as outlined above, either it be the first or the second closeable vessel (201,215 and/or 301,315), will facilitate using a minimum of liquid, for instance a surface-modifying liquid. A slideable (302) holder will also facilitate using the same portion of surface-modifying liquid or of any other kind of liquid to more than one set of microfluidic devices.

The second vessel (315) is typically larger and intended for larger volumes of less precious liquids such as washing liquids (313) as described for FIG. 2e above.

The arrangement may also comprise one or more liquid removal devices for removing liquid from the interior of the microchannel structures of a microfluidic device submitted to the method of the invention. Such a device may include a dryer that is based on evaporation by the use of application of an air stream, heat and/or reduced pressure at one or more of the ports communicating a microconduit part containing the liquid that has been previously introduced and is to be removed in step (III). Air streams may be created by fans, by suction or by blowing of a gas, typically warm and/or dry gas, such as air or nitrogen, spinning of the device etc.

A particular useful method for removing the liquid introduced into the microchannel structure is to replace the liquid introduced in step (I) during a first or a subsequent round with some kind of other fluid, for instance a gas, such as air, or another liquid, for instance a washing liquid. The preferred liquid removal device of this kind utilizes centrifugal force obtained by spinning the microfluidic device about a spin axis. This variant requires that it is possible to orient the microfluidic device such that liquid is present in a part of a microchannel structure that is closer to the spin axis than the port intended as the port through which liquid is to be removed. In the case the microchannel structure comprises a bent that is directed outwardly from the spin axis this bent may trap liquid that cannot be removed by centrifugal force created by spinning about the selected spin axis. Such trapped liquids may be removed by a) refilling the microchannel structures with liquid, such as a washing liquid, and repeated spinning about the same spin axis as before, b) changing orientation of the devices relative to the spin axis used in the first instance (=changing spin axis), c) evaporation as contemplated in the previous paragraph, d) applying other driving forces for liquid transport out of the microchannel structures, for instance electrokinetic transport, etc. Refilling according to (a) may take place by utilizing reduced pressure in the same manner as described for the invention.

Other forces than centrifugal force can be used for replacing a liquid introduced in step (I) with another fluid. Typical such forces may be electrokinetic or non-electrokinetic.

Devices for removal of liquid from microchannel structures of a microfluidic device may have a special container in which the removal of liquid is taking place. This container should be capable of containing a holder containing a plurality microfluidic devices, typically at least the same number as placed in a holder (202,302,212,312) used in step (I) of a first or a subsequent round. In preferred variants removal of liquid takes place by a combination comprising evaporation as discussed above and replacement with another fluid with the same preferences as discussed above. An advantageous liquid removal device is a so-called Spin Rinse Dryer. It follows that a spinner for removal of liquid is preferably included in the arrangement to be used for carrying out the method of the invention.

Surface-Modifying Liquid

A surface-modifying liquid contains one or more surface modification agents that are capable of changing the chemical and/or physical surface characteristics of an inner surface of a microchannel structure. A typical surface modification agent is present in dissolved and/or dispersed form in the surface-modifying liquid and does not normally encompass solvent molecules as such that during the modification procedure are physically adsorbed. A typical surface modification agent is present in the surface-modifying liquid in an amount that ≦40%, such as ≦30% or ≦15% (wt-%) or lower.

Dispersed surface modification agents may be in the form of particles, e.g. beads.

Soluble or dissolved surface modification agents primarily change the chemical surface characteristics of the surface to be modified while particulate and otherwise insoluble variants primarily change the physical surface characteristics. Certain soluble or dissolved surface modification agents may during the modification process result in particulate or otherwise insoluble products indicating that soluble agents also could be used for physical surface modifications. Polymerisable dissolved surface modification agents, for instance, may result in porous beds, such as porous plugs, in the microconduit part containing the surface to be modified by locally initiating the polymerization as known in the field. This may take place by local initiation of polymerization for instance by irradiation. Suitable soluble variants of surface modification agents may be found amongst ionic or non-ionic hydrophilic and/or hydrophobic polymers as described in 0147638 (Gyros AB), WO 0056808 (Gyros AB), WO 9800709 (Amersham Pharmacia Biotech AB), U.S. Pat. No. 6,236,023 (Caliper) etc including derivatives in the form of conjugates that for instance may contain functional groups facilitating binding of the polymer to the inner surface of a microchannel structure of a microfluidic device. Soluble variants also include reactive species that activate the surface and/or lead to the formation, stabilization or binding of a layer or a plug at an inner surface in the microfluidic device. Formation, stabilization and binding may include cross-linking.

Insoluble surface modification agents in the form of particles may be used to change the roughness of the surface or for the introduction of porous packed beds. In most instances this means that the place for formation of packed bed is defined by a constriction of the microconduit part. The dimension of the constriction is such that the liquid but not the particles can pass through the constriction. See for instance WO 0275775 (Gyros AB), WO 0275776 (Gyros AB), WO 02074438 (Gyros AB) and WO 0275312 (Gyros AB). See also WO 03099438 (University of Alberta).

Microfluidic Device

Microfluidic devices which are particularly well-fitted to undergo the surface modification method of the present invention will now be emphasized.

Suitable microfluidic devices are well known in the field. See for instance discussion about background technology/publications in WO 02074438 (Gyros AB).

A suitable microfluidic device typically has an n-numbered axis of symmetry (Cₙ) that is perpendicular to or coinciding with the plane of the disc. n is typically an integer 2, 3, 4, 5, 6, 7 or larger, for instance ∞ (C_{∞}) (round forms). By defining a spin axis that is coinciding with or is perpendicular to the axis of symmetry and manufacturing the microfluidic device such that each microchannel structure comprises a substructure that extends from an upstream inner part to a downstream outer part, liquid flow can be driven in the microchannel structure by spinning the device about the spin axis. In this context an inner part is closer to the spin axis than an outer part. Circular, conical, cylindrical and spherical forms are examples of forms that have a C_{∞}-axis of symmetry perpendicular to the disc plane and in which liquid flow can be driven by spinning the device around a spin axis that coincide with the C-axis. See for instance WO 9721090 (Gamera Bioscience), WO 9853311 (Gamera Bioscience), WO 0056808 (Gyros AB), WO 0146465 (Gyros AB), WO 0147637, (Gyros AB), WO 02074438 (Gyros AB), WO 02075312 (Gyros AB), WO 03018198 (Gyros AB), WO 03024598 (Gyros AB), and WO 02075776 (Gyros AB). By equipping this kind of devices with a central hole they can easily be mounted on the pin (204,304) holder (202,302) described above in the context of FIGS. 2-3.

PCT/SE03/01850 (Gyros AB) describes that centrifugal force and spinning for driving liquid flow also can be applied to non-circular microfluidic devices that have

a) other kinds of Cₙ-axes, and

b) a spin axis that is not perpendicular to the disc plane.

Illustrative devices are rectangular discs with a Cₙ-axis in the plane of the disc and a spin axis that may be outside the disc and/or parallel to the plane of the disc.

These variants typically require other designs of holders for the removal step (III) in the case centrifugal force used for removal of liquid from the microchannel structures.

The number (plurality) of microchannel structures on a device is typically ≧10, such as ≧25 or ≧90 or ≧180 or ≧270. An upper limit may be 2000 or 3000.

A microfluidic device that has an axis of symmetry discussed above typically has a size that corresponds to the size of a compact disc with a radii in the interval 10% up to 500% of the radii of a conventional compact disc (CD). The size and/or form of a conventional CD is/are at present preferred.

The microchannel structures are in the microformat by which is meant that each of them has at least one cross-sectional dimension that is ≦10³ or ≦10² or ≦10¹ μm, in particular at the location of the inner surface to be modified in accordance with the invention. The volumes of the aliquots dispensed to and/or processed within a microchannel structure are typically in the μl-format that includes the nl-format. The μl-format is ≦5000 μl, such as ≦1000 μl or ≦100 μl or ≦10 μl and the nl-format is ≦1000 nl, such as ≦100 nl or ≦10 nl.

The device may be made from different materials, such as plastic material, glass, silicone etc. Polysilicone is included in plastic material. From the manufacturing point of view plastic material is many times preferred because it is normally cheap and mass production can easily be done, for instance by replication. Typical examples of replication techniques are embossing, injection moulding etc. See for instance WO 9116966 (Pharmacia Biotech AB). Replication processes typically result in open microchannel structures as an intermediate product, which, subsequently is covered by a top substrate or lid. See for instance WO 0154810 (Gyros AB) or by methods described in publications cited therein. Plastic materials as a rule have a too low wettability for acceptable capillary transport and a significant non-desired adsorption. This means that good surface modification methods many times will be of utmost importance for the manufacture of high-quality disposable microfluidic devices in plastic materials.

FIG. 1 gives an enlarged view from above of a subgroup (151) of 12 microchannel structures (152a,b . . . ) of a circular microfluidic device (150) having all the ports that that is present in the ready-made microfluidic device. The structures are designed such that liquid transport can be created by spinning the device about the centre of the device (=C_{∞}-axis of symmetry). The device (150) has a circumference (153). The inward/upward direction towards the centre of the device (150) is indicated with an arrow (154). Details about this particular design and function have been given in WO 02075312 (Gyros AB) and WO 03024598 (Gyros AB). There is a meander-like distribution manifold (155) that is common to all the microchannels structures (152) of the subgroup and comprises one volume-metering microcavity (156) per microchannel structure (12 volume-metering microcavities in total). The manifold has two inlet ports for liquid (157,158) and one outlet port for liquid (159). Each volume-metering microcavity (156a,b . . . ) of the manifold (155) is defined between the two neighbouring air vents (160a′ and a, a and b, b and c etc) in two neighbouring upward bents (161a′ and a, a and b, b and c etc) and in the downstream direction by the valve function (162a,b . . . ) in the lowest part of the downward bent (163a,b . . . ) located between the two neighbouring upward bents (161a′ and a, a and b, b and c etc). For each microchannel structure (152a,b . . . ) there is also a separate inlet port (164 . . . i . . . ) that is connected to a single volume-defining unit (165 . . . i . . . ) that comprises a volume-metering microcavity (166 . . . i . . . ) that is defined between the junction (167 . . . i . . . ) of an overflow microconduit (168 . . . i . . . ) with an inlet microconduit (169 . . . i . . . ) and a valve function (170 . . . i . . . ) at the outlet end of the volume-metering microcavity (166 . . . i . . . ). An additional valve function (171) is associated with the central common inlet port (158). An additional valve function (172 . . . e . . . ) is also associated with the outlet (173 . . . e . . . ) of each overflow microconduit (168 . . . e . . . ) into the common waste chamber (174). Each microchannel structure (152a,b . . . ) may also comprise a reaction microcavity (175 . . . c . . . ) which in the downstreram direction is delineated by a constriction (dual depth) (176 . . . c . . . ). Additional hydrophobic surface breaks are indicated as rectangles and function as valves, vents or anti-wicking means. Additional ports to ambient atmosphere are indicated by circles. For details see WO 02075312 (Gyros AB).

Noteworthy is also the outwardly directed U-shaped restriction microconduits (177a,b . . . ) that will prevent complete removal of all liquids introduced in step (I) by centrifugal force created by spinning the device around its axis of symmetry. For this kind of structure other kinds of removal operations will be necessary as a complement. See above.

In the same manner as for previously known microfluidic structures, a microchannel structure comprises all functional units that make it possible to carry out an intended process protocol within the device. A functional part or unit that is common for two or more microchannel structures is also part of each individual microchannel structure it is common for. This apply for common inlet and outlet ports, common distribution manifolds, common waste chambers etc

With respect to performing a process protocol in the ready-made device, the subgroup (151) of microchannel structures comprises the following ports that potentially can be used as ports (PT′) for the filling step (I) when carrying out the surface modification according to the invention.
a) two common inlet ports (157,158) for process liquids;
b) one single inlet port (164 . . . i . . . ) per microchannel structure (152 . . . i . . . ) for liquid, in total twelve;
c) one common outlet port (159) for excess liquid and for venting;
d) one venting outlet port (178 . . . f) per microchannel structure (152 . . . f . . . ) that also may be for outlet of liquid (in total twelve) plus a separate outlet port (179) directly connected to the central inlet port (158);
e) one venting outlet ports (180 . . . c . . . ) per microchannel structure (152 . . . c . . . ) which are not used for liquids;
f) one common venting outlet port (181) that is not used for liquids.

The valve functions are typically of the non-closing type as defined in WO 02074438 (Gyros AB) and WO 03018198 (Gyros AB), such as a passive valve that preferably is based on a boundary between a local hydrophobic surface area or break in an otherwise hydrophilic microchannel. That a surface is wettable or hydrophilic primarily means that its water contact angle is ≦90°, such as ≦70° or ≦60° or ≦45° or ≦30°. That a microconduit/microchannel structure is hydrophilic means that water can be transported by capillary action (self-suction) within the microconduit or within at least a part of a microchannel structure. Hydrophobic or non-wettable surfaces typically have water contact angles that are ≧90° under some circumstances the value of the water contact angle may be below this value but are then typically above 70° such as above 80°. A hydrophilic microconduit or microchannel structure may comprise hydrophilic as well as hydrophobic inner surfaces, for instance one or two and possibly also three sidewalls may be hydrophobic.

The most critical sections with respect to non-desired adsorption and/or wettability are located upstream the most downstream reaction microcavity, which in the microchannel structures of FIG. 1 is the reaction microcavity (175a,b . . . ). Therefore ports (157,158,159,181, 164a,b . . . ) that are upstream these reaction microcavities (175a,b . . . ) may be the primary targets for inlet of the surface-modifying liquid in step (I) according to the invention in the case the modification aims at providing generally hydrophilic microchannel structures or microconduit with low non-desired adsorption. In this context the ports for outlet and/or inlet of liquids (157,158,159,164a,b . . . ) may be more important than the ports solely used as venting ports (180a,b . . . , 181) and possibly also the ports (178a,b . . . ) bearing in mind that ports that are not used typically should be closed during the filling step (I). In the simplest variant all the ports are treated as PT′ ports and left open for filling the structures with the surface-modifying liquid or any other liquid in subsequent rounds of the method.

This differences discussed in the preceding paragraph between the ports becomes particular important in the case one aims at a local surface modification, for instance for modifying
a) the chemical surface characteristics in the distribution manifold (155) or in the volume-metering microcavities (166a,b . . . ) that are linked to a single microchannel structure (152a,b . . . ) or in the reaction microcavity (175a,b . . . ) that is present in each microchannel structure (152a,b . . . ), and
b) the physical surface characteristics for instance by introducing a porous bed in the reaction microcavities (175a,b . . . ).

In these variants it may become important with a selective introduction via certain ports and relying upon downstream valve functions for not spreading the surface-modifying liquid unintentionally within the microchannel structures to non-desired sections. For instance by proper balancing the reduced pressure against the flow resistance created by the passive valves (152a,b . . . ) at the outlets of the distribution manifold (155) and/or passive valves (170a,b . . . ) at the outlet of each single volume-defining unit (165a,b . . . ) into the reaction microcavities (175a,b . . . ), one can envisage that it should be possible to selectively fill either the distribution manifold (155) or each single volume-defining unit (165a,b . . . ) with the surface-modifying liquid and then in a subsequent step by spinning the device cause transport down into each individual reaction microcavity (175a,b . . . ). In the case the surface-modifying liquid contains dispersed particles as the surface modification agent, the physical surface characteristics will be changed by the formation of a packed bed against the dual depth/constriction (176a,b . . . ) for each reaction microcavity/microchannel structure (175a,b . . . /152a,b . . . ). In the case the surface-modifying liquid contains an analyte and each of the reaction microcavities (175a,b . . . ) comprises an immobilized capturing reactant, the chemical surface characteristics in the reaction microcavities will be changed by capturing of the analyte. In the similar manner in principle any kind of local surface modification can be carried out within a reaction microcavity, including also immobilization of various kinds of reactants that are needed in a desired process protocol to be performed in the ready-made microfluidic device.

A certain local surface characteristics may be present in a microchannel structure (152a,b . . . ) prior to a general treatment according to the invention and it may be important to maintain these local surface characteristics. Typical such local surface characteristics are hydrophobic breaks which are used as venting functions, valve functions, anti-wicking functions etc. See above. To secure that these local functions are retained, the surface is typically generally pretreated to promote surface modification by the surface-modifying liquids to be used according to the invention followed by a treatment that locally introduces the surface characteristics that is to be maintained during application of the inventive method. Typically these kind of pre-treatment steps are carried out while the microchannel structure is in uncovered form. Compare for example WO 0147638 (Gyros AB) and WO 0056808 (Gyros AB) in which the uncovered microchannel structures in a plastic surface is first plasma hydrophilized to introduce negatively charged groups and then locally hydrophobized whereafter a lid is attached to the surface and a solution containing a conjugate between polyethylene glycol and polyethylene imine as the surface modification agent is introduced into the covered microchannel structure. One can also envisage local surface modification by filling a microconduit part of a microchannel structure with a surface-modifying solution containing an externally activatable surface-modifying system into a microconduit part of a microchannel system and then by local initiation of the system cause a local modification of the surface characteristics of the inner surface. The activatable system may be a polymerization system that is activatable by irradiation or by some other kind of externally applied activation principle.

Certain innovative aspects of the invention are defined in more detail in the appending claims. Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for the modification of an inner surface in each of one, two or more microchannel structures of a microfluidic device, each of the microchannel structures comprises one, two or more ports (PT) communicating with ambient atmosphere, said method comprising for each of the microchannel structures the steps of:
(I) filling a microconduit part that comprises the inner surface to be modified with a liquid containing a surface modification agent (surface-modifying liquid) through at least one port (PT′) of said two or more ports (PT),
(II) incubating said liquid within said microconduit part, and
(III) removing said liquid from said microconduit part, for instance from the microchannel structures comprising said microconduit part,
wherein reduced pressure is utilized for filling in step (I).

2. The method according to claim 1, wherein said microfluidic device comprises two or more microchannel structures that comprises the inner surface to be modified, and that at least one of steps (I)-(III) is carried out in parallel for said two or more microchannel structures.

3. The method according to claim 1, wherein for each of said microchannel structures
(a) there are at least one port communicating with one end of the microconduit part (PT₁ ports) and at least one other port communicating with the other end of the microconduit part (PT₂ ports), and
(b) the surface-modifying liquid being sucked through one or more of the PT₁ ports by applying reduced pressure through one or more of the PT₂ ports while keeping remaining ports closed.

4. The method according to claim 1, wherein said method comprises the steps of:
i) providing
A) a closed vessel that contains a liquid phase which contains the surface modification agent, and a gas phase, and
B) said microfluidic device in which each of said microchannel structures is empty and via said at least one port (PT′) is in contact with a) said liquid phase, or b) said gas phase, while the remaining ports, if any, are closed;
ii) reducing the gas pressure in said vessel,
iii) bringing said at least one port in contact with said liquid phase if step (i) is according to alternative (b),
iv) increasing the gas pressure in the vessel, typically to atmospheric pressure, whereupon said liquid is entering each of said microchannel structures through said at least one port (PT′) during
step (ii) for alternative (a), and
step (iv) for alternative (b).

5. The method according to claim 4, wherein step (ii), step (iii) if present, and step (iv) are carried out while the microfluidic device is placed within said vessel.

6. The method according to claim 4, wherein steps (ii)-(iv) are carried out with at least a major portion of each of said microchannel structures being placed outside said vessel while said at least one inlet port (PT′) is communicating with the interior of said vessel.

7. The method according to claim 4, wherein one or more of said at least one port (PT′) is one end of a capillary tube attached at its other end to a major body that comprises at least the major part of each of the microchannel structures.

8. The method according to claim 4, wherein said microfluidic device during step (I) is placed in a holder which is capable of holding a plurality of said microfluidic device.

9. The method according to claim 1, wherein for each of said microchannel structure, step (III) comprises evaporating via at least one port (PT″) of said two or more ports (PT) at least partially the liquid introduced into said microconduit part in step (I), for instance by application of reduced pressure, an air stream and/or heat to at least one port (PT′″) which typically is PT″.

10. The method according to claim 1, wherein for each of said microchannel structures, step (III) comprises at least partially removing through at least one port (PT′″) of said ports (PT) the liquid introduced into said microconduit part in step (I), said removing encompassing replacing said liquid with a fluid selected amongst gases and liquids.

11. The method according to claim 1, wherein
A) said microfluidic device permits the use of centrifugal force for said removal (step III), and
B) said removal (step III) comprises the steps of:
a) transferring said microfluidic device to a centrifugal device adapted to create the centrifugal force required for said removal,
b) centrifuging said microfluidic device, typically while it is retained in a holder which is capable of holding a plurality of said microfluidic device, and
c) optionally drying the interior of said one or more microchannel structures by evaporation from at least one of said one or more inlet and outlet ports, preferably while said microfluidic device is retained on a holder which is capable of holding a plurality of said microfluidic device.

12. The method according to claim 1, wherein the method is repeated once, twice or more times with said microfluidic device with the liquid used in step (I) having the same or different composition as the liquid used in a previous round.

13. The method according to claim 12, wherein the liquid used in step (I) of a repetitive round is selected amongst a) liquids containing a surface modification agent that is of the same or different kind or concentration as the surface modification agent of the first round, b) washing liquids, and c) conditioning liquids.

14. The method according to claim 1, wherein
a) said liquid of step (I) in the first round or in a repetitive round contains an analyte to be determined in a process to be carried out within each of said microchannel structures, and
b) each of said microchannel structures comprises on said inner surface a capturing function for retaining said analyte.

15. The method according to claim 1, wherein
a) said liquid of step (I) in the first round or in a repetitive round contains a reagent or reactant to be used in a process to be carried out within each of said microchannel structures,
b) each of said microchannel structures comprises in said inner surface a capturing function for retaining said reactant or reagent.

16. The method according to claim 1-13, wherein
a) said liquid of step (I) in the first round or in a repetitive round is a dispersion of particles,
b) each of said microchannel structures comprises in said microconduit part a capturing function for retaining said particles.

17. The method according to claim 1, wherein said liquid of step (I) in the first round or in a repetitive round has a boiling point at atmospheric pressure that is ≧70° C., preferably ≧80° C.

18. The method according to claim 1, wherein step (I) comprises the steps of:
a) providing a plurality of said microfluidic device, and
b) processing the microfluidic devices of said plurality in parallel according to steps (I)-(III) with preference for carrying out step (I) as described in claim 4 or in any of its dependent subclaims.
